(19) United States
(12) Patent Application Publication
(10) Pub. No.: US 2012/0308737 A1
(43) Pub. Date: Dec. 6, 2012

(54) METHOD FOR ANTISEPTIC PROCESSING OF THE SURFACE OF A PRODUCT MADE OF SILICONE RUBBER MATERIAL

(76) Inventors: Ara Arshavirovich Abramyan, Moscow (RU); Mikhail Mefodievich Afanasyev, Moscow (RU); Viacheslav Ivanovich Beklemyshev, Moscow (RU); Igor Ivanovich Makhonin, Mendeleevo (RU); Umberto Orazio Giuseppe Maugeri, Calvignano (IT); Vladimir Aleksandrovich Solodovnikov, Moscow (RU)

(21) Appl. No.: 13/261,324

(22) PCT Filed: Dec. 14, 2010
(86) PCT No.: PCT/EP2010/069632

§ 371 Date: Jun. 15, 2012

(30) Foreign Application Priority Data
Dec. 15, 2009 (RU) RU2009146340

(51) Int. Cl. B05D 3/06

(52) U.S. Cl. 427/539

(57) ABSTRACT

The invention concerns a method for antiseptic processing of the surface of a product made of organosilicon rubbers with molecular weight 2·10⁵−6·10⁵, said method consisting in a two stages formation of an antiseptic coating on said surface of said product: (a) at a first stage said surface is modified by treatment in low-temperature oxygen plasma at high-frequency electromagnetic radiation; and (b) at a second stage the modified surface is processed applying on it an antiseptic preparation containing: a biocide, which is a nanodispersed powder of bentonite intercalated by ions of silver or/and copper; a fluoroacrylic polymeric binding agent, wherein said binding agent is dissolved in a mixture of fluoroalkylethers. The method provides the formation of a coating having effective antiseptic and operational properties especially when the coating is applied on the surface of small orthopedic devices such as foot-correctors, insoles, heel pads, etc.

### FIELD OF THE INVENTION

The invention relates to the field of antiseptic coating compositions and uses thereof for antiseptic superficial processing of objects made of polymeric materials; in particular the invention concerns a method for antiseptic superficial processing medical devices made of polymeric material and more in particular small-scale orthopaedic devices.

### STATE OF THE ART

The major factors in the choice of an antiseptic mean to be applied for processing of surfaces of products are its efficiency in relation to pathogenic microorganisms, the degree of toxicity, duration of action and usability.

Superficial processing of medical devices is preferably carried out in antiseptic water or hydroalcoholic solutions.

Guanidine compounds are traditionally applied in medical practice as antiseptic components for processing of surfaces of medical devices including those made of polymeric materials.

Biocidal activity of guanidine compounds is carried out by the guanidinium cation which interacts with negatively charged bacterial cell. The cation, adsorbed on the cell surface, brings to destruction of bacteria blocking their breath, nutrition and transport of metabolites through the cellular wall.

According to the state of the art knowledge, for superficial processing both low-molecular (chlorhexidine) and high-molecular guanidine compounds (polyhexamethyleneguanidine (PHMG)) are applied.

However the given preparations are toxic; efficiency of their action to microorganisms is various.

At present time a significant attention is given to obtaining antiseptic preparations based on metals having bactericidal action: Ag, Au, Pt, Pd, Cu, and Zn (see H. E. Morton, Pseudomonas in Disinfection, Sterilisation and Preservation, ed. S. S. Block, Lea and Febider 1977 and N. Grier, Silver and Its Compounds in Disinfection, Sterilisation and Preservation, ed. S. S. Block, Lea and Febiger, 1977). Thus the preparations having metal-containing components with particles in the nanometer range and basically ultradispersed biocides containing silver are the most promising. [see Blagitko E. M., etc. <<Silver in medicine>>, Novosibirsk: the Science-center, 2004, 256 p.].

The patent RU N. 2330673/2008, which is considered the closest prior art of the present invention, describes antiseptic superficial processing of a device by applying on the surface of said device a composition consisting of a biocide in the form of a nanodispersed powder of bentonite intercalated by ions of silver or/and copper in a solution of a polymeric binding agent. The bentonite particles size is not more than 150 nanometers.

The above known antiseptic coating is effective on surfaces of devices made of organic polymers materials but is ineffective when applied as coating on the surface of devices made of organosilicon (polydimethylsiloxane) rubbers with molecular weight 2·10⁵−6·10⁵ which are used for manufacturing of products of small-scale orthopaedics (foot-correctors, insoles, heel pads, etc.).

Ineffectiveness onto organosilicon rubbers can be explained as follows:
significant hydrophobicity of the surface of organosilicon (polydimethylsiloxane) rubbers due to a characteristic superficial orientation of the hydrocarbon radicals which results in lowering of adhesive properties of said materials;
low resistance, to loadings arising during the use, of the antiseptic coating when applied on the working surface of small-scale orthopaedics devices.

Taking into consideration that organo silicon rubbers with molecular weight 2·10⁵−6·10⁵ are optimum with reference to the density, elasticity and hardness for manufacturing of orthopedic devices the use of which requires effective antiseptic processing, it is therefore evident that it is quite necessary to create a reliable antiseptic coating for the processing of a surface of devices made of organosilicon rubbers as those employed in small-scale orthopaedics.

Application of an antiseptic preparation known from patent RU N. 2330673 for these purposes is ineffective due to low operational properties of a formed coating at interaction with a living tissue.

The problem of the invention consists in providing a method for antiseptic processing the surface of a product made of polymeric materials with the next technical results:
obtaining a coating on a surface of products manufactured from polymeric materials on the basis of organosilicon (polydimethylsiloxane) rubbers with molecular weight 2·10⁵−6·10⁵ with effective antiseptic and operational properties;
preservation of functional properties of these materials at operation of products.

### SUMMARY OF THE INVENTION

Taking into consideration chemical, thermal stability and high hydrophobicity of the rubbers with molecular weight 2·10⁵−6·10⁵ the inventors solved the aforesaid problems by means of plasma-chemical processing for modifying a working surface of a product. This process is widely applied in various branches of techniques, including medicine, for modification of a surface of polymeric materials. However, plasma-chemical processing is accompanied, for example, by metallization of a superficial layer. It is inexpedient for products from organosilicon rubbers the use of which requires preservation of their functional properties (density, elasticity, hardness).

The present invention solve the aforesaid problems by means of a method for antiseptic processing a surface of a product made of organosilicon rubbers with molecular weight 2·10⁵−6·10⁵, said method consisting in a two stages formation of an antiseptic coating on said surface of said product:

(a) at a first stage said surface is modified by treatment for (2-3)±1 minutes in low-temperature oxygen plasma with a charge of oxygen (O₂) 0,8-7 l/h, working pressure (70-135)±5 Pa, at high-frequency electromagnetic radiation with frequency of 13,56 MHz and capacities 20-40 Wt; and

(b) at a second stage the modified surface is processed applying on it an antiseptic preparation containing:
a biocide, which is a nanodispersed powder of bentonite intercalated by ions of silver or/and copper, the bentonite powder having particles size not higher than 150 nanometers;
a fluoroacrylic polymeric binding agent, wherein said binding agent is dissolved in a mixture of perfluoroalkylethers.

According to the above method a coating with effective antiseptic and suitable operational properties was obtained on the surface of a product made of organo silicon (polydimethylsiloxane) rubbers with molecular weight 2·10⁵−6·10⁵. Polydimethylsiloxane is the material preferably used for manufacturing orthopaedics devices and after the above antiseptic processing the functional properties of the rubber were preserved.

### DETAILED DESCRIPTION OF THE INVENTION

Preferably said polymeric binding agent is a fluoroacrylic polymer in solvent, wherein said solvent is selected among fluoroalkyl ethers, such as perfluoroisobutylmethyl ether, perfluorobutylmethyl ether and their mixtures. Preferably the polymeric binding agent is mixed with said solvents in the following wt % ratios:

| | |
|---|---|
| fluoroacrylic polymer | 1-3 |
| perfluoroisobutylmethyl ether | 20-80 |
| perfluorobutylmethyl ether | 20-80, |

The antiseptic preparation has the following ratio of components: biocide:polymeric binding agent in solvent, as 1:(50-100) weight parts.

According to a preferred embodiment of the invention a mix of nanodispersed powders of bentonite intercalated by ions of silver and ions of copper was applied as biocide in the antiseptic preparation at a ratio:

bentonite intercalated by silver ions: bentonite intercalated by cooper ions, as 1:(0,5-1) weight parts.

The effectiveness of the process of the invention can be explained by the next:
design of a two steps process wherein the application of plasma-chemical processing for modifying the surface of a product to be antiseptically processed results in the surface getting hydrophilic properties because silanol (Si—OH) and siloxane (Si—O—Si) groups are formed following the low temperature oxygen treatment;
the application, in the second step of the process, on the surface to be treated of an antiseptic preparation containing mineral biocide nanodispersion, a polymeric binding agent as fluoroacrylic polymer and fluoroalkylether solvent (namely perfluoroisobutylmethyl and perfluorobutylmethyl ethers). Application of the given antiseptic preparation provides an effective adhesive interaction with the modified surface.

In result a new coating with the antiseptic effect, not altering physical and chemical properties of the rubber material and not causing irritating influence on the skin of a human being is obtained.

As far as the Applicant is aware of there is no prior art disclosure describing the process of the invention nor other method that could allow to achieve similar results.

The present invention can be industrially realized with application of known technological equipments and of products and materials suitable for realization of the invention. It could be better understood by the below description of embodiments of the invention.

Experimental Part

Materials and Equipment

The following materials are used for realization of the method of the invention:
biocide, i.e. a nanodispersed powder of bentonite intercalated by ions of silver (Ag⁺) or/and zinc (Zn²⁺). Given biocide is manufactured according to the patent RU N. 2330673. Bentonite (montmorillonite) in Na-form, sodium chloride (NaCl), silver nitrate (AgNO3), copper sulfate (Cu2SO4) are applied for manufacturing a biocide according to the above cited Russian patent application. Process of manufacturing of a dispersed powder of biocide is carried out in two stages. A semifinished item of bentonite activated by ions of sodium is obtained at the first stage and the semifinished item is intercalated by ions of silver or copper by reactions of ionic exchange of sodium to ions of silver or copper at the second stage;
application of a nanodispersed powder of bentonite intercalated by ions of silver or a mix of powders of bentonite intercalated by ions of silver and copper is preferable for realization of the invention at a ratio: 1:1 (weight parts) because it decreases costs.
commercial product EGC-1700, trade mark Novec, the manufacturer is the company 3M (US). The given product is made on the basis of fluoroacrylic polymer and both perfluoroisobutylmethyl and perfluorobutylmethyl ethers. The product on the basis of fluoroacrylic polymer with solvents as perfluoroisobutylmethyl and perfluorobutylmethyl ethers is also applied for formation of coatings on products of medical purposes. It has biological compatibility. The product is nontoxic and is also applied for formation of coatings on contact lenses made of silicon rubbers;
the laboratory research equipment intended for plasma-chemical processing of products. The equipment contains a working chamber with a system of loading and unloading of products, systems of pumping out and supply of oxygen in the chamber, the generator of high-frequency electromagnetic radiation with working frequency −13,56 MHz and power up to 1 kW and a control system;
samples of organosilicon rubbers with molecular weight 3·10⁵. The area of the surface of the samples is 5 μm². The specified kind of organosilicon rubbers is applied for manufacturing of products of small-scale orthopaedics, for example, foot correctors.

Technological process of the invention for the formation of antiseptic coatings on the surface of devices made of organosilicon (polydimethylsiloxane) rubbers with molecular weight 2·10⁵−6·10⁵ is carried out using the above mentioned materials, products and the equipment. The chosen type of materials for antiseptic processing is optimal for manufacturing of products of medical purposes, in particular, small-scale orthopaedics due to the functional features (density roughly 1,5-1,6 gr/sm³).

Application of the specified technological operations, the modes, applied materials and products for realization of the invention provides obtaining on work surfaces of products of an antiseptic coating having a prolonged action and biologically compatible with living tissues. Besides, it possesses effective operational characteristics during interaction with them.

Variations from the specified conditions, modes and materials are not expedient and will lead to deterioration of results or to increase of the whole process realization costs, or to change of physical and chemical properties of the device material. In particular, physical and chemical properties of the device material are broken increasing the high-frequency electromagnetic radiation and an effective modification of a surface is not provided if the high-frequency electromagnetic radiation is decreased.

Realization of the invention is explained by the following concrete examples:

### Example 1

An antiseptic coating was formed on a sample surface made of organosilicon rubbers having molecular weight 3·10⁵. The process for forming the antiseptic coating was carried out in two stages.

Stage (a)—Modification of the Sample Surface.

Samples were loaded into a suitable laboratory-research equipment chamber. A vacuum of 133 Pa was produced in the chamber. Oxygen (O₂) was fed into the chamber at a rate of 0,8 l/hour. The sample was irradiated for a 2 minute period by a high-frequency electromagnetic radiation −30 Wt and frequency −13.56 MHz. The surface of the sample was thus modified and the surface got hydrophilic properties in result of plasma-chemical processing at the specified aforementioned conditions in an environment of low-temperature oxygen plasma.

Stage (b)—Coating of the Modified Surface with an Antiseptic Composition.

An antiseptic composition is prepared by mixing:
biocide in the form of a nanodispersed powder of bentonite intercalated by ions of silver (Ag⁺) with dimension of particles of the powder not more than 100 nanometers. The nanodispersed powder of bentonite is obtained according to patent RU N. 2330673;
a polymeric binding agent in the form of a 2% solution of perfluoroisobutylmethyl and perfluorobutylmethyl ethers (commercially available from 3M as EGC-1700) the rest.

The above antiseptic mixture contains: biocide/product EGC-1700 respectively in amounts=1:50 (weight parts).

The antiseptic composition obtained as above described is applied on the modified surface of the rubber sample.

### Example 2

A surface sample identical to that of example 1 is modified according to stage 1 as above described and then is coated with an antiseptic composition differing from that of example 1 in the biocide which in this case is consisting of a mixture of nanodispersed powders of bentonite intercalated by ions of silver and copper at a ratio as 1:1 (weight parts).

### Example 3

### Control

A surface sample identical to that of example 1 is modified according to stage 1 as above described and then is coated with an antiseptic composition containing:
biocide in the form of a nanodispersed powder of bentonite intercalated by silver ions (Ag⁺) with dimension of particles of a powder not more than 100 nanometers. The nanodispersed powder of bentonite is obtained according to patent RU N. 2330673;
polymeric binding agent in the form of a 0,75% w/w alcohol solution of a block-copolymer of polydimethylsiloxane and polyurethane wherein said binding agent is according to the patent RU N. 2330673 (commercially available as Penta-1009).

The above said antiseptic composition contains: biocide: a solution of a polymeric binding agent, respectively in amounts 1:100 (weight parts).

The coated samples according to examples 1-3 were characterized and tested as follows:
determination of the moistening contact angle. This parameter is the most sensitive for determining the quality of surfaces or coatings applied on a working surface. The moistening contact angle was determined on an experimental drop of a liquid to a surface of the samples according to examples 1-3;
biotesting of antimicrobic properties. The named properties of the samples according to examples 1-3 were estimated at modelling of process of operation of products at carrying out of the given method of testing.

### Example 4

### Determination of Contact Angles

The contact angles (θ, θ₁, θ₂, θ₃, θ₄ and θ₅) of a deionized water drop deposited on sample surfaces resulted as follows:
on the surface of the initial sample made of organo silicon rubbers (molecular weight 3·10⁵), before stage 1 of treatment with low-temperature oxygen plasma the contact angle (θ) was 108°;
on the surface of the sample (as example 1) after modification in low-temperature plasma the contact angle (θ₁) was 73°;
on the surface of the sample (as example 1) after the second stage of processing the contact angle (θ₂) was 95°;
on the surface of the sample (as example 3) after the second stage of processing the contact angle (θ₃) was 85°;
on the surface of the samples (accordingly, examples 1 and 3) after the second stage of processing in 24 hours of retention of the samples at room temperature the contact angle (θ₄) (a sample by an example 1) was 92°; the contact angle of moistening (θ₅) (a sample by an example 3) was 80°.

The above results can be resumed as follows:
treatment of a rubber surface by low-temperature oxygen plasma increased the adhesive properties of the surface;
the antiseptic coating applied after oxygen plasma treatment resulted with adhesive properties increased with respect to the starting rubber surface.

### Example 5

### In Vitro Antimicrobic Assay

The above obtained samples (examples 1-3) were tested for their antimicrobic properties.

Estimation of antimicrobic properties was carried out by a standard technique with application of a of culture Staphylococcus aureus. The culture has been obtained in the environment of beef-extract agar (BEA) within 24 hours at temperature 37° C. Homogeneous suspension of cells in deionized water was prepared then. The prepared structure at amount of 1 ml of suspension was brought in Petri's dishes with a dried BEA environment and was uniformly allocated on a surface of environment by a sterile spatula for germination of culture by a dense lawn. Then slices of (1×1) (cm²) of samples obtained according to examples 1-3 were densely applied on a surface of agar by a sterile tweezers. Slices of samples were placed at a distance of 2 cm from each other and at a distance about 2,5 cm from the center of a dish. Seeded dishes with samples were thermostatically controlled at 37° C. Antimicrobic properties of each slice of sample were determined by formation of zones of inhibition of growth of strains of a microorganism which were precisely allocated on a background of a dense lawn of growth of tested culture. Determination of antimicrobic properties was carried out having subjected the tested samples to (5 times) washings with water, these washings having been selected as simulation of operational conditions of orthopedic products.

It resulted that the growth of Staphylococcus aureus strain is, for samples according to examples 1-2 after five washings, 30% lower than that of the sample according to example 3.

The estimation of antimicrobic properties of examples 1 and 2 has also shown that antimicrobic properties of the antiseptic coating obtained by the example 1 are more effective than similar properties of the coating obtained by example 2. This confirms the known data about the argentiferous preparations possessing a wide spectrum of antimicrobic activity. At the same time costs of manufacture of the given product considerably increases what is inexpedient.

Thus, the carried out researches as a whole testify the efficiency of the method of the invention for antiseptic processing of the surface of a product made of organosilicon rubbers with molecular weight 2·10⁵−6·10⁵.

1. A method for antiseptic processing the surface of a product made of organosilicon rubbers with molecular weight of 2·10⁵−6·10⁵, said method consisting in a two stages formation of an antiseptic coating on said surface of said product:
(a) at a first stage said surface is modified by treatment for (2-3)±1 minutes in low-temperature oxygen plasma with a charge of oxygen (O₂) 0,8-7 l/h, working pressure (70-135)±5 Pa, at high-frequency electromagnetic radiation with frequency of 13,56 MHz and capacities 20-40 Wt; and
(b) at a second stage the modified surface is processed applying on it an antiseptic preparation containing:
a biocide, which is a nanodispersed powder of bentonite intercalated by ions of silver or/and copper, the bentonite powder having particles size not higher than 150 nanometers;
a fluoroacrylic polymeric binding agent, wherein said binding agent is dissolved in a mixture of perfluoroalkylethers.

2. Method according to claim 1 wherein said perfluoroalkylethers are chosen among perfluoroisobutylmethyl and perfluorobutylmethyl ethers.

3. Method according to claim 1 wherein the binding agent is a solution containing the following components expressed in wt % parts:

| | |
|---|---|
| fluoroacrylic polymer | 1-3 |
| perfluoroisobutylmethyl ether | 20-80 |
| perfluorobutylmethyl ether | 20-80. |

4. Method according to claim 1 wherein the antiseptic preparation has the following ratio of components: biocide:polymeric binding agent in solvent, as 1:(50-100) weight parts.

5. Method according to claim 1 wherein the biocide is a mix of nanodispersed powders of bentonite intercalated by ions of silver and copper having the following ratio:
bentonite intercalated by silver ions:bentonite intercalated by copper ions, as 1:(0, 5-1) weight parts.
